(19) United States
(12) Patent Application Publication
(10) Pub. No.: US 2008/0267253 A1
(43) Pub. Date: Oct. 30, 2008

(54) Method to Optimise Temperature Regulation in Technological Processes

(75) Inventors: Luca Baraldi, Osteria Grande (IT); Cosimo Raone, Osteria Grande (IT)

Correspondence Address: OBLON, SPIVAK, MCCLELLAND MAIER & NEUSTADT, P.C., 1940 DUKE STREET, ALEXANDRIA, VA, 22314, US

(73) Assignee: Baraldi Chemgroup SRL, Osteria Grande (IT)

(21) Appl. No.: 11/547,130

(22) PCT Filed: Apr. 14, 2004
(86) PCT No.: PCT/IB2004/001128

§ 371 Date: Oct. 4, 2006

(51) Int. Cl. G01J 5/02

(52) U.S. Cl. 374/121; 700/300

(57) ABSTRACT

Method to optimise temperature regulation in technological processes comprising the following phases: Detection of the temperature on the dies, transmission of the data to a computer equipment (9) which is able to compare them with predefined values. Temporary retroaction on the running technological process using a specific release agent fluid (12) which is able to take off little heat from the die to reduce the WARM-UP phase (8).

### FIELD OF THE ART

The present invention concerns the technology of procedures to detect the temperature distribution in a technological process. International Classification G 01 J.

### STATE OF THE ART

It is known the application of sensors to detect occasionally the thermologic parameters which concern the course of technological processes.

The present invention suggests improvements to optimise the temperature regulation in the WARM-UP phase of technological processes where the detection of the service temperature distribution is realised through the automatic and programmable execution of explorative excursions performed through adjustable equipment connected to a protective structure with shutter which contains a pointer device and a radiation sensor, which after having performed the detection of thermologic process parameters, sends them to a computer which processes, visualises and records them to control and regulate the distribution of the service temperatures in the course of the process.

### DESCRIPTION

The invention is now described with reference to the schematic figures of the drawings attached as a not limiting example.

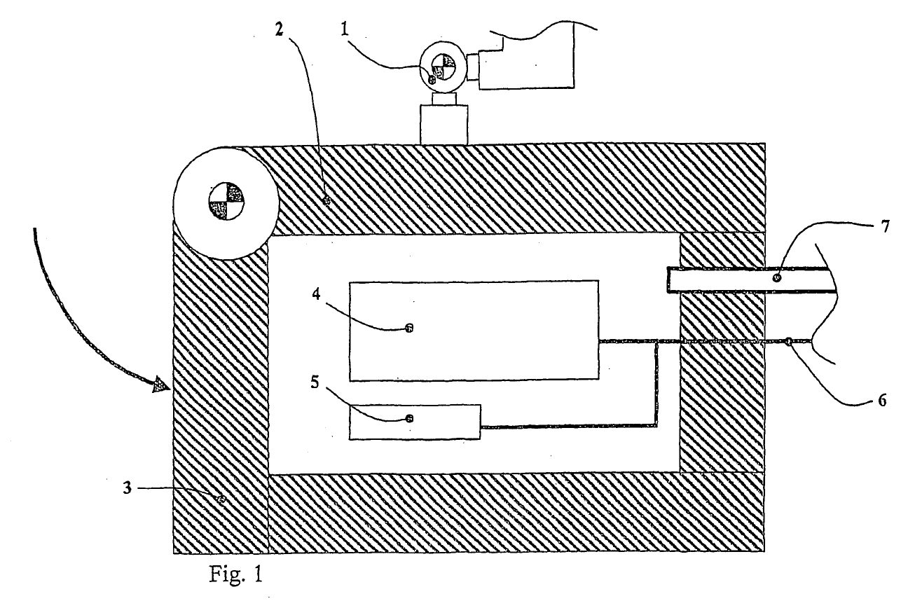

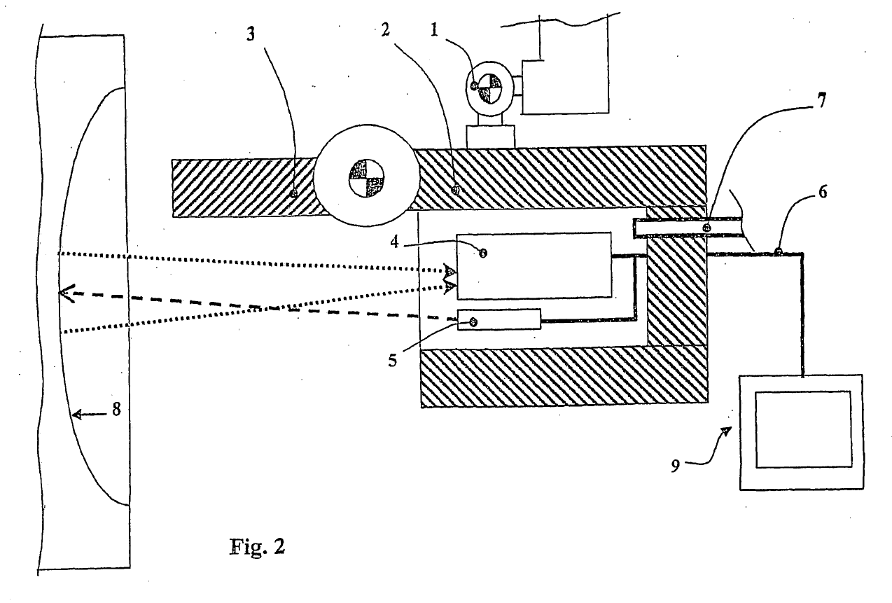

FIG. 1 represents schematically the protective structure with the shutter (3) in closed position

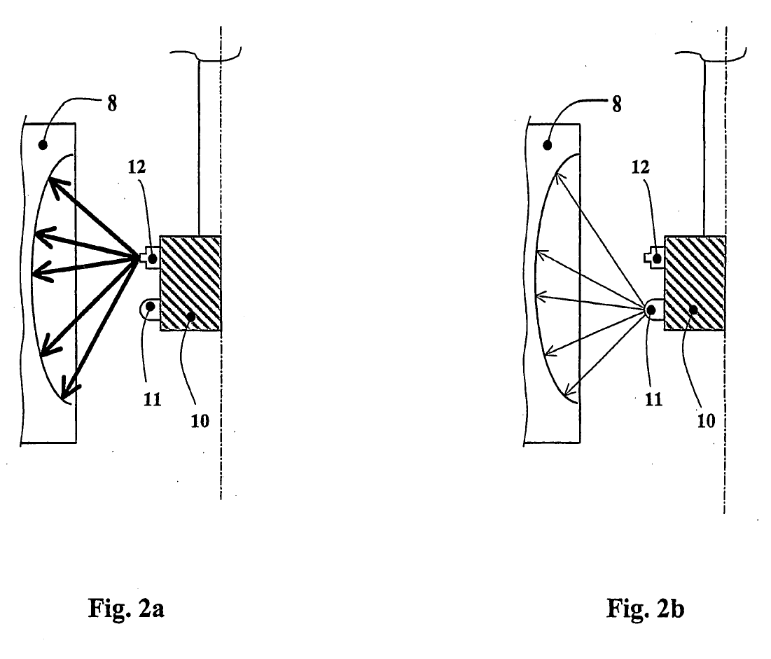

FIG. 2 represents schematically the protective structure with the shutter (3) in open position.

One can notice the presence within the protective structure of a pointer device (5) and of a radiation sensor (4) that, after having performed the detection of the thermologic parameters of the process, sends them to the computer equipment (9) that processes them and records them to control and regulate the distribution of the service temperatures at the wall's surface (8).

FIG. 2a represents schematically the intervention of a specific release agent fluid (12) which has the purpose to take off little heat from the die (8) in order to reduce the WARM-UP phase.

FIG. 2b represents schematically the intervention of a generic release agent fluid (11) for carrying out correctly the technological process.

In the figures each single detail is marked as follows:

1 indicates an adjustable equipment whose explorative excursions, programmed by the computer (9), are automatically performed;
2 is a protective structure;
3 is a shutter;
4 is a radiation sensor to detect the thermologic parameters of the process to be inspected;
5 is a pointer device to place the detecting;
6 indicates the connecting cables of the computer equipment;
7 indicates the pneumatic connection to allow the introduction of air in the protective structure;
8 is a wall at whose surface the distribution of the service temperatures should be detected;
9 indicates the computer equipment;
10 indicates the device that introduces the sprayers between the die halves at each cycle;
11 indicates the sprayer of the traditional water based release agent fluid;
12 indicates the sprayer of the specific fluid for the WARM-UP phase.

The equipment works as follows:

During Continuous Running of the technological process:
management of the program of automatic excursions of the adjustable equipment (1);
   acquisition and processing of the thermologic parameters detected by the sensor (4) and their transduction in temperature values;
visualisation and mapping of the distribution of the temperature values upon the explored surface (8);
control and regulation of the technological process to optimise the distribution of the service temperatures.

### During the Warm-Up Phase:

DETECTION of the thermologic parameters of the die (8) through explorative excursions performed through adjustable equipment (1) connected to a protective structure (2) which contains a pointer device (5) and a radiation sensor (4).

TRANSMISSION of the detected data to a computer equipment (9) which processes, visualises and records them as temperature values. These values are compared, at each cycle, with predefined sample values, to obtain signals which carry out retroaction controls operating on the running technological process.

Temporary RETROACTION on the running technological process using a specific release agent fluid (12) which has the purpose to take off little heat from the die (8) during the WARM-UP phase in order to reduce the necessary number of cycles to let the die (8) reach the normal thermal operating conditions and reduce the time of the single cycle of the technological process.

SWITCHING, controlled by the computer equipment (9), from the fluid (12) to the traditional water based release agent fluid (11) by sending another control signal after achievement of the normal thermal operating conditions.

The evidence of the figures highlights the simplicity and the reliability of the procedure which can be purposely applied in metallurgic plants, especially in die-casting and moulding plants or in similar technological processes.

It should be pointed out the importance of the fact that the shutter (3), opening only when the detection is performed, protects always the sensor (4) and the pointer (5) from the environmental disturbances of the metallurgic process.

Furthermore, it should be pointed out that the resulting mapping of the values of the process temperatures allows to have a synoptic view of the present conditions of the process. It also allows the simultaneous detection of possible critical zones which require more attention in the regulation of the cooling system.

The invention could be realised with technological solutions and with structural proportioning and dimensioning which could fit different technical needs.

All the methods to detect the distribution of service temperatures in a technological process, which will feature the characteristics as basically described, shown and hereinafter claimed, will be considered part of the protection sphere of the present invention.

1) Improvements to optimise temperature regulation in technological processes CHARACTERIZED BY THE FACT THAT THEY INCLUDE FOLLOWING OPERATIONS:
DETECTION of the thermologic parameters of the die (8) through explorative excursions performed through adjustable equipment (1) connected to a protective structure (2) with shutter (3) which contains a pointer device (5) and a radiation sensor (4).
TRANSMISSION of the detected data to a computer equipment (9) which processes, visualises and records them as temperature values. These temperature values are compared, at each cycle, with predefined sample values, to obtain signals which carry out retroaction controls operating on the running technological process.
Temporary RETROACTION on the running technological process using a specific release agent fluid (12) which has the purpose to take off little heat from the die (8) during the WARM-UP phase in order to reduce the necessary number of cycles to let the die (8) reach the normal thermal operating conditions and reduce the time of the single cycle of the technological process.
Automatic SWITCHING, controlled by the computer equipment (9), from the fluid (12) to the traditional water based release agent fluid (11), by sending another control signal after achievement of the normal thermal operating conditions.
